(19) United States
(12) Patent Application Publication
(10) Pub. No.: US 2009/0307231 A1
(43) Pub. Date: Dec. 10, 2009

(54) Information collecting device, information collecting system, information collecting method, and computer program

(75) Inventors: Kosuke Matsunaga, Oita-shi (JP); Koki Togashi, Matsumoto-shi (JP); Eiichi Tokonami, Oita-shi (JP); Minoru Ichimura, Shiojiri-shi (JP)

Correspondence Address: EDWARDS ANGELL PALMER & DODGE LLP, P.O. BOX 55874, BOSTON, MA, 02205, US

(73) Assignee: Seiko Epson Corporation, Tokyo (JP)

(21) Appl. No.: 12/455,250

(22) Filed: May 29, 2009

(30) Foreign Application Priority Data
May 29, 2008 (JP) 2008-140721

(51) Int. Cl. G06F 17/40; G06F 17/30

(52) U.S. Cl. 707/10; 707/E17.032; 707/E17.005

(57) ABSTRACT

An information collecting device includes: a network interface unit which receives information on consumables from a plurality of devices connected through a network; a database access unit which accesses a database storing the information on consumables of each of the devices; and a control unit which controls the network interface unit and the database access unit. The information on consumables contains a device ID assigned to each of the devices and the consumption number of consumables as the number of consumables consumed by each of the devices. From the database, the database access unit acquires a value of a device ID field used to store the device ID, a value of a previous quantity field used to store the consumption number of consumables received at previous time, and a value of a total number field used to store the total number of consumables consumed by each of the devices.

The entire disclosure of Japanese Patent Application No. 2008-140721, filed May 29, 2008 is expressly incorporated by reference herein.

### BACKGROUND

1. Technical Field

The present invention relates to a technique for collecting information on consumables of a device.

2. Related Art

As a technique for collecting information on consumables, there is known a technique disclosed in JP-A-2000-259050, for example, which is the technique for storing count information on copied sheets in the EEPROM by mounting a ROM board including an EEPROM on a copy apparatus.

However, the count information may be lost when the ROM board is replaced. Therefore, a problem occurs in that the cumulative number of sheets copied in the copy apparatus cannot be obtained even when the count information is collected from the ROM board of the copy apparatus after the loss of the count information.

In general, this problem commonly occurs not only in the copy apparatus but also in the case where information on consumables of a device is collected.

### SUMMARY

An advantage of some aspects of the invention is that it provides a technique for collecting the total cumulative number of consumables in a device on the basis of the consumption number of consumables consumed in the device.

The following aspects of the invention can be realized in order to solve some of the above-described problems.

According to an aspect of the invention, there is provided an information collecting device including: a network interface unit which receives information on consumables from a plurality of devices connected through a network; a database access unit which accesses a database storing the information on consumables of each of the devices; and a control unit which controls the network interface unit and the database access unit. The information on consumables contains a device ID assigned to each of the devices and the consumption number of consumables as the number of consumables consumed by each of the devices. From the database, the database access unit acquires a value of a device ID field used to store the device ID, a value of a previous quantity field used to store the consumption number of consumables received at previous time, and a value of a total number field used to store the total number of consumables consumed by each of the devices. The control unit stores the consumption number of consumables in the previous quantity field and maintains the value of the total number field without update, when a difference value obtained by subtracting the value of the previous quantity field from the consumption number of consumables received from each of the devices is negative.

In this way, it is possible to appropriately maintain the total cumulative number of consumables in the device by storing the consumption number of consumables in the previous quantity field, when the difference value obtained by subtracting the value of the previous quantity field from the consumption number of consumables is negative.

In the information collecting device according to the above aspect of the invention, the control unit may store the consumption number of consumables in the previous quantity field and may add the difference value to the value of the total number field, when the difference value is positive. Accordingly, it is to obtain the total cumulative number of consumables in the device.

In the information collecting device according to the above aspect of the invention, the control unit may control the database access unit so as to store a predetermined initial value in the total number field, when the information on consumables received from each of the devices is the first information on each of the devices. Accordingly, it is possible to carry out a flexible operation by changing the initial value.

According to another aspect of the invention, there is provided an information collecting system including: an information collecting device; and a database server, wherein the information collecting device includes a network interface unit receiving information on consumables from a plurality of devices connected through a network, a database access unit which accesses a database storing the information on consumables of each of the devices, and a control unit which controls the network interface unit and the database access unit, wherein a table of the database server includes a device ID field used to store a device ID, a previous quantity field used to store the consumption number of consumables received at previous time, and a total number field used to store the total number of consumables consumed by each of the devices, wherein the information on consumables contains the device ID assigned to each of the devices and the consumption number of consumables as the number of consumables consumed by each of the devices, wherein from the database, the database access unit acquires a value of the device ID field, a value of the previous quantity field, and a value of the total number field, and wherein the control unit stores the consumption number of consumables in the previous quantity field and maintains the value of the total number field without update, when a difference value obtained by subtracting the value of the previous quantity field from the consumption number of consumables received from each of the devices is negative.

According to still another aspect of the invention, there is provided an information collecting method including: (a) receiving information on consumables from a device connected through a network; and (b) accessing a database which stores the information on consumables of the device, wherein the information on consumables contains a device ID assigned to the device and the consumption number of consumables as the number of consumables consumed by the device, and wherein (b) the accessing includes: (b1) accessing a device ID field used to store the device ID; (b2) accessing a previous quantity field used to store the consumption number of consumables received at previous time; (b3) accessing a total number field used to store the total number of consumables consumed by the device; and (b4) storing the consumption number of consumables in the previous quantity field and maintaining a value of the total number field without update, when a difference value obtained by subtracting a value of the previous quantity field from the consumption number of consumables received from the device is negative.

According to still another aspect of the invention, there is provided a computer program allowing a computer to execute a reception function receiving information on consumables from a device connected through a network; and an access function accessing a database which stores the information on consumables of the device. The information on consumables contains a device ID assigned to the device and the consumption number of consumables as the number of consumables consumed by the device. The access function includes: a function accessing a device ID field used to store the device ID; a function accessing a previous quantity field used to store the consumption number of consumables received at previous time; a function accessing a total number field used to store the total number of consumables consumed by the device; and a function storing the consumption number of consumables in the previous quantity field and maintaining a value of the total number field without update, when a difference value obtained by subtracting a value of the previous quantity field from the consumption number of consumables received from the device is negative.

According to still another aspect of the invention, there is provided a recording medium which records the computer program having the above configuration.

Various aspects of the invention can be realized. For example, the information collecting method and the information collecting device, the information collecting system, the computer program for realizing functions of the information collecting method and the information collecting device, and the recording medium recording the computer program can be realized.

### BRIEF DESCRIPTION OF THE DRAWINGS

The invention will be described with reference to the accompanying drawings, wherein like numbers reference like elements.

FIG. 1 is an explanatory diagram illustrating the general configuration of an information collecting system according to an aspect of the invention.

FIG. 2 is a block diagram illustrating functions of the information collecting system.

FIG. 3 is a flowchart illustrating a process sequence of a control unit of an application server.

FIG. 4 is an explanatory diagram illustrating a process flow of the information collecting system.

FIG. 5 is an explanatory diagram illustrating the contents of data at respective time points of FIG. 4.

FIG. 6 is a flowchart illustrating a process sequence of a control unit of an application server according to a comparative example.

FIG. 7 is an explanatory diagram illustrating a process flow of an information collecting system according to the comparative example.

FIG. 8 is an explanatory diagram illustrating the contents of data at respective time points of FIG. 7.

### DESCRIPTION OF EXEMPLARY EMBODIMENTS

Hereinafter, an embodiment of the invention will be described in the following sequence:

A. Embodiment,

B. Comparative Example, and

C. Modified Example.

### A. Embodiment

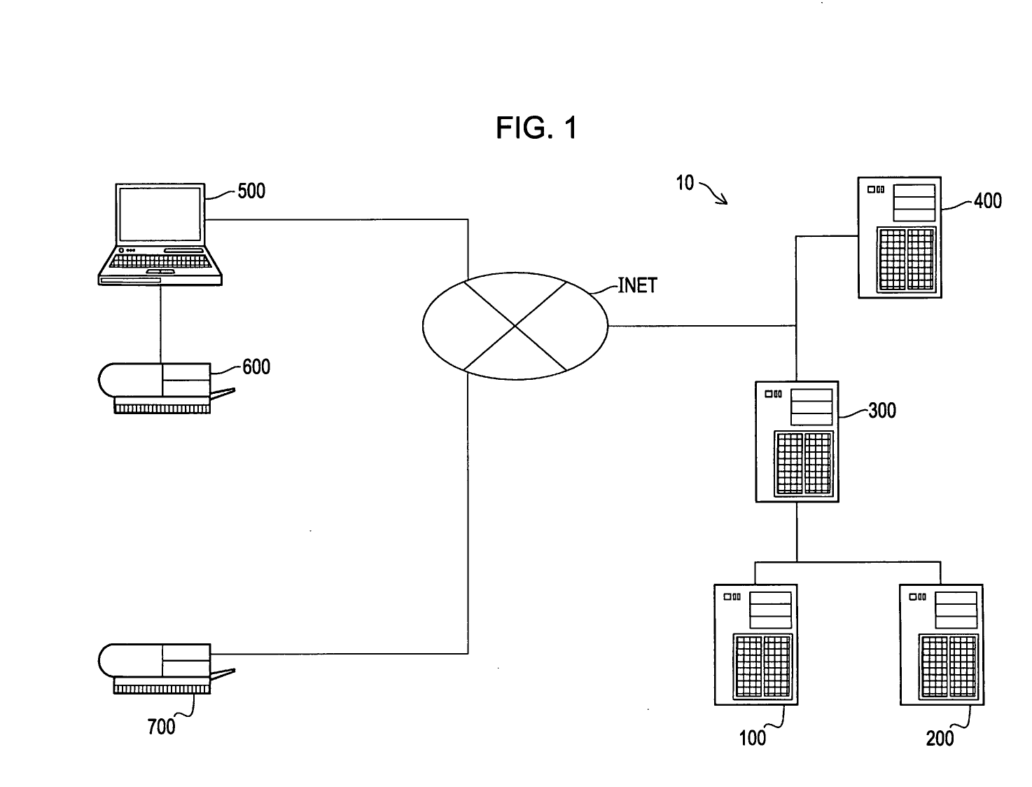

FIG. 1 is an explanatory diagram illustrating the generation configuration of an information collecting system according to an embodiment of the invention. An information collecting system 10 includes an application server 100, a database server 200, a firewall 300, and a WEB server 400. The application server 100 and the database server 200 are installed in an area (an internal network) inside the firewall 300 in order to guarantee the security. On the other hand, the WEB server 400 is installed in the outside (an external network) of the firewall 300. Alternatively, the WEB server 400 may be configured such that a network area (DMZ) isolated between the internal network and the external network is provided and the WEB server 400 is installed in the DMZ. In consideration of the security of the WEB server 400, it is preferable that the WEB server 400 is installed in the DMZ.

The information collecting system 10 includes a client computer 500 as a client connected through the Internet INET and a network printer 700. The client computer 500 as a proxy of a printer 600 having no function directly connecting with a network is a computer which functions as a client of the information collecting system 10. A network printer 700 is a printer which can directly connect with a network and thus functions as a client of the information collecting system 10. A plurality of the clients are connected to the information collecting system 10, but each one of these clients is illustrated in FIG. 1 for convenient illustration.

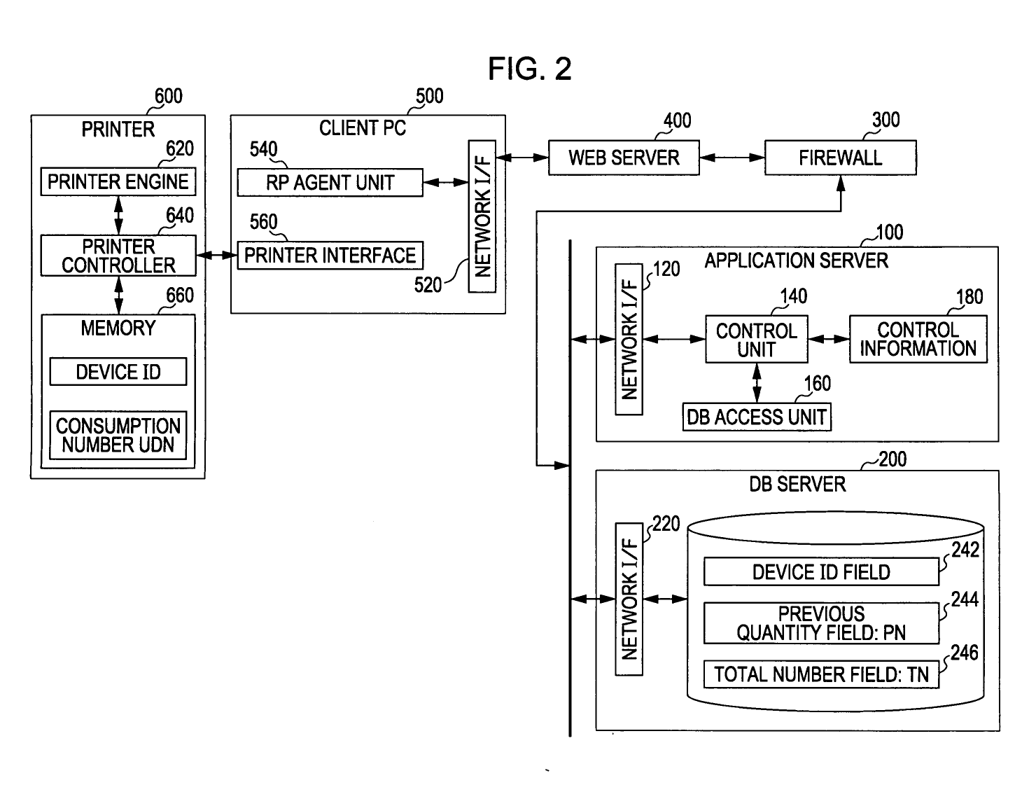

FIG. 2 is a block diagram illustrating functions of the information collecting system. The printer 600 includes a printer engine 620, a printer controller 640, and a memory 660. The printer engine 620 is a mechanism which actually performs printing. The printer controller 640 is a computer having a CPU (not shown). The printer controller 640 receives printing job data from the client computer 500 and controls the printer engine 620 in accordance with the printing job to allow the printer engine 620 to perform the printing. The printer controller 640 transmits a device ID stored in the memory 660 and a consumption number UDN of consumables to the client computer 500. The memory 660 is a storage area having a ROM or a RAM (not shown) and stores the device ID and the consumption number UDN of consumables. The device ID is an identifying sign for identifying the individual printers 600. The consumption number UDN of consumables is the number of consumables consumed in the printer 600. For example, a consumption number of ink cartridges can be used as the consumption number UND of consumables. In addition, it is preferable that the consumption number UDN of consumables is stored in a non-volatile memory such as an EEPROM capable of electrically rewriting contents. The non-volatile memory storing the consumption number UDN of consumables is generally mounted on a ROM board.

The client computer 500 includes a network interface 520, an RP agent unit 540, and a printer interface 560. The network interface 520 is an interface used when the client computer 500 connects with the network. The RP agent unit 540 is a software normally loaded in the client computer 500 and functions to transmit the device ID and the consumption number UDN of consumables stored in the memory 660 of the printer 600 to the WEB server 400. The transmission can be performed at arbitrary time when the client computer 500 is connected to the network. The printer interface 560 is an interface which connects the client computer 500 to the printer 600. The client computer 500 acquires the device ID and the consumption number UDN of consumables of the printer 600 through the printer interface 560.

The WEB server 400 is a server which is located in the external network and receives information from a client to transmit the information to the application server 100. The firewall 300 functions as isolating the application server 100 and the database server 200 from the external network to protect the servers against dangers or viruses of the external network.

The application server 100 includes a network interface 120, a control unit 140, a DB access unit 160, and control information 180. The network interface 120 is an interface used when the application server 100 connects with the network. The control unit 140 controls the DB access unit 160 on the basis of information received through the network interface 120. The DB access unit 160 obtains an access to the database server 200 to read or write information. The control unit 140 and the DB access unit 160 are provided on a CPU (not shown) of the application server 100. The control information 180 is information necessary when the control unit 140 performs controlling and is stored in a memory such as a ROM or a RAM (not shown) of the application server 100.

The database server 200 includes a network interface 220 and a database 240. The network interface 220 is an interface used when the database server 200 connects with the network. The database 240 is a storage area in which data constructed in the database server 200 are stored. For example, the database 240 can be realized by using a relational database management system (RDBMS). A table of the database 240 contains a device ID field 242, a previous quantity field 244, and a total number field 246. The device ID field 242 is a field for storing a device ID stored in the memory of the printer 600. The previous quantity field 244 is a field used to store the consumption number PN of consumables notified at previous time from the printer 600. The total number field 246 is a field used to store the total number (cumulative consumption number) TN of consumables used in the printer 600. Communication between the respective devices and the servers connected to the each other through the network can be realized by TCP/IP, for example.

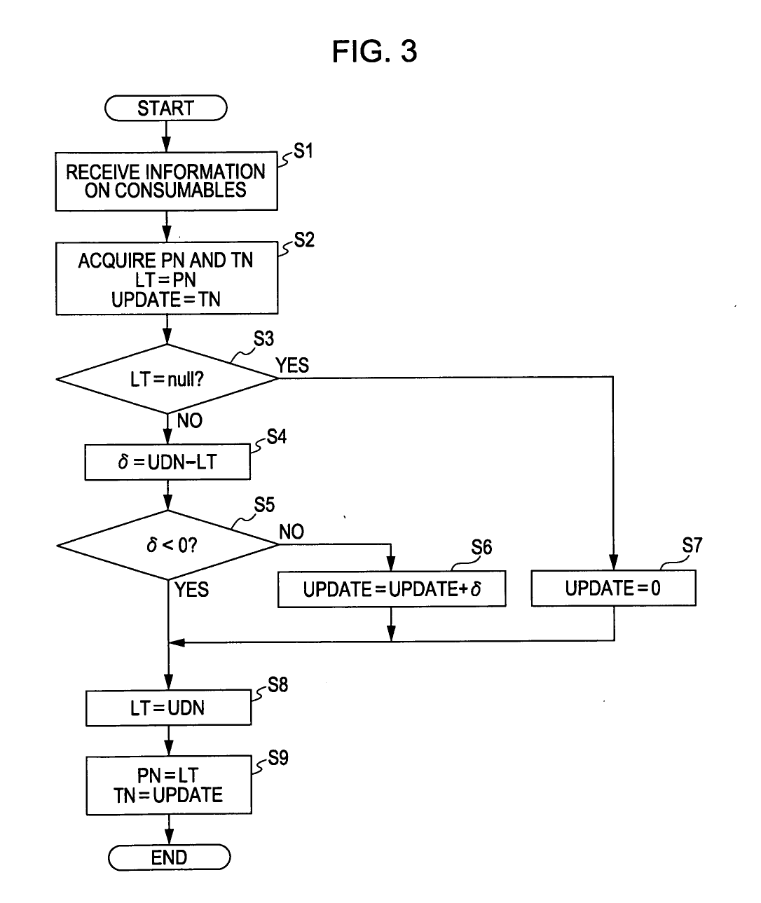

FIG. 3 is a flowchart illustrating a process sequence of the control unit 140 of an application server 100. The control unit 140 mainly performs the controlling in accordance with the flowchart. The following variables are used in a process described below:

(1) information on consumables from a client,

UDN: the consumption number of consumables,

(2) values of fields in database,

PN: a value of the previous quantity field,

TN: a value of the total number field,

(3) internal variables of the application server,

LT: a variable maintaining the value PN of the previous quantity field,

UPDATE: a variable maintaining the value TN of the total number field, and

δ: a difference value (UDN−LT)=(UDN−PN).

In Step S1, information on the consumables transmitted from the client computer 500 is received through the network interface 120. The information on the consumables transmitted from the client computer 500 contains the device ID and the consumption number UDN of consumables. Even though the detailed description is omitted in FIG. 3, it is preferable that a client authentication process and a data alteration check are performed in the reception process. In Step S2, the control unit 140 performs controlling so as to acquire the value PN of the previous quantity field 244 and the value TN of the total number field 246 in the DB access unit 160. Subsequently, the control unit 140 stores the value PN of the previous quantity field 244 in the variable LT. Likewise, the value TN of the total number field 246 is stored in the variable UPDATE. In Step S3, it is determined whether the value of the variable LT is null (initial invalid value). When the value of the variable LT is null, 0 is stored in the variable UPDATE in Step S7 and the process proceeds to Step S8. Alternatively, when the value of the variable LT is not null, the difference value (UDN−LT) obtained by subtracting the value of the variable LT from the value of the consumption number UDN of consumables is stored in the variable δ in Step S4. In this embodiment, the value of the variable δ represents an increment of the consumption number UDN of consumables until present time from the previous time of receiving data. The determination in Step S3 may be made by determining whether the value of the variable UPDATE is null. In Step S5, it is determined whether the value of variable δ is negative. When the value of the variable δ is 0 or positive, the value of the variable δ is added to the value of the variable UPDATE in Step S6, and then the process proceeds to Step S8. Alternatively, when the value of the variable δ is negative, the process proceeds to Step S8. In Step S8, the value of the consumption number UDN of consumables is stored as the value of the variable LT. In Step S9, the DB access unit 160 is controlled so that the value of the variable LT is written to the previous quantity field 244. Likewise, the DB access unit 160 is controlled so that the value of the variable UPDATE is written to the total number field 246. The writing to the total number field 246 may be performed only when the value of the variable UPDATE is updated.

According to the above-described sequence, the value of the variable δ is added to the value TN of the total number field in Steps S6 and S8, when the value of the variable δ is positive. Alternatively, when the value of the variable δ is negative, the variable UPDATE is not changed and the value TN of the total number field is thus maintained without change. As understood from the process in Steps S2 and S4, the value of the variable δ is obtained by subtracting the value PN of the previous quantity field from the value of the consumption number UDN of consumables received at the present time. Therefore, when the value of the variable δ is positive, the cumulative consumption number of consumables can be obtained by adding the value of the variable δ to the value TN of the total number field. Alternatively, when the value of the variable δ is negative, it is assumed that an abnormality (for example, replacement of the ROM board of the printer 600) occurs in the consumption number UDN of consumables. Therefore, when the value of the variable δ is negative, the cumulative consumption number of consumables can be maintained with an appropriate value by maintaining the value TN of the total number field.

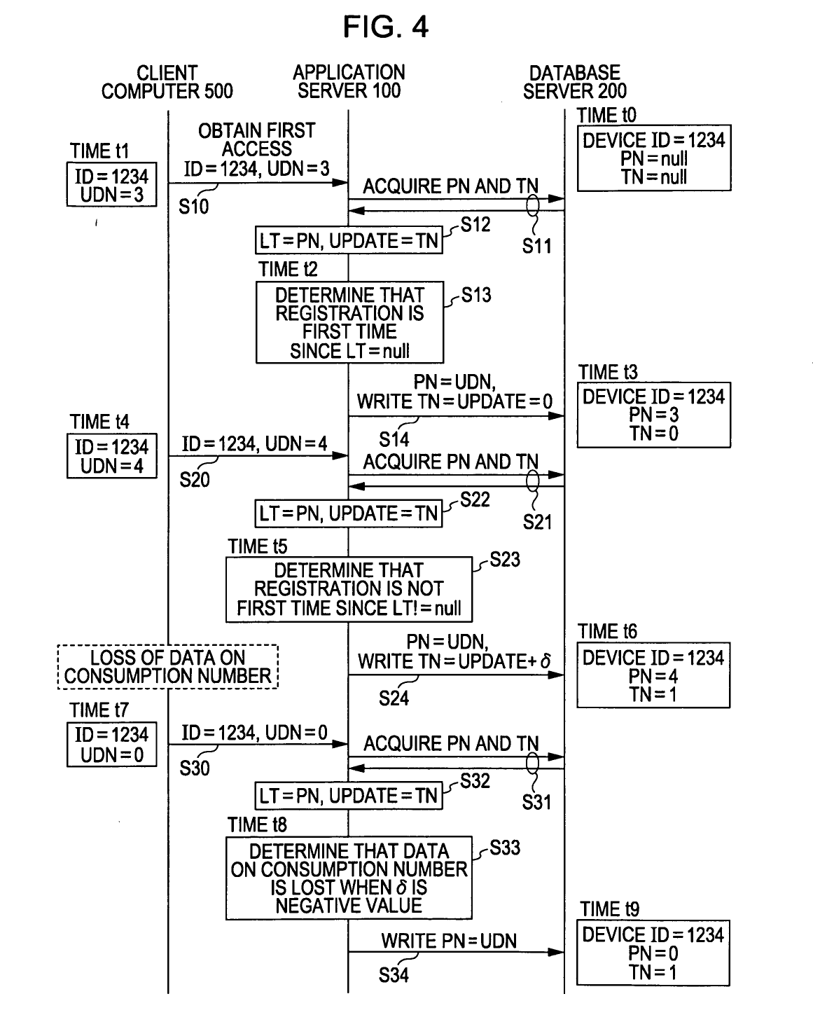

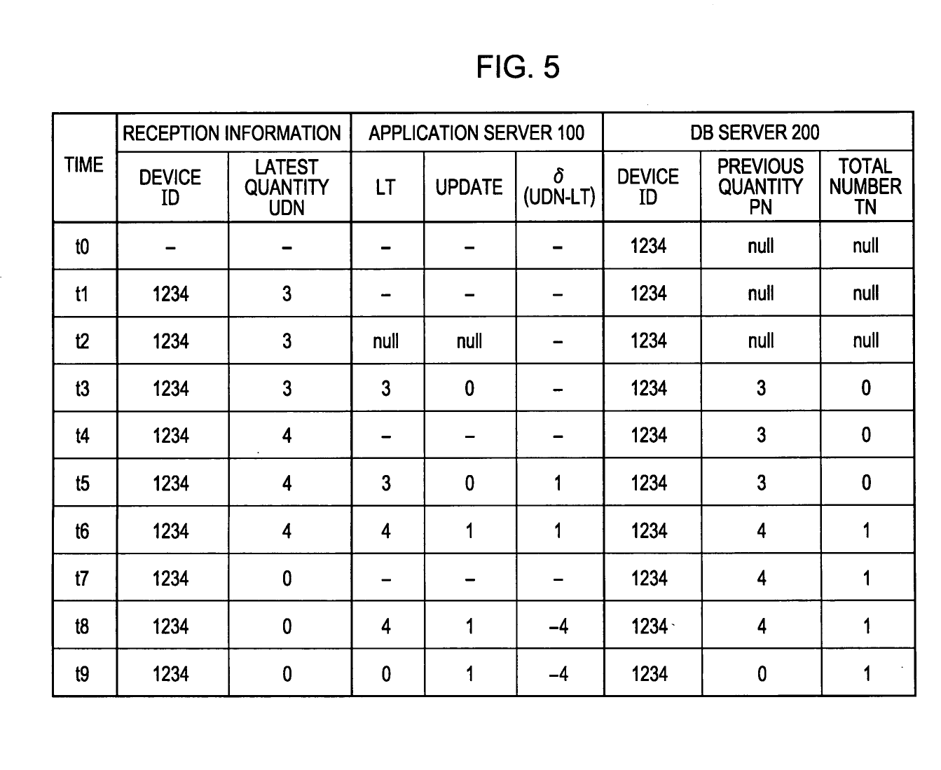

FIG. 4 is an explanatory diagram illustrating a process flow of the information collecting system 10. FIG. 5 is an explanatory diagram illustrating the contents of data in respective time points of FIG. 4. Hereinafter, the process flow of the information collecting system 10 will be described with reference to FIGS. 4 and 5. Since the firewall 300 and the WEB server 400 are just paths of the client computer 500, the firewall 300 and the WEB server 400 are not illustrated in FIG. 4.

Here, a state where information is not once received from a client having the device ID “1234” is called an initial state. At time t0 of the initial state, the value PN of the previous quantity field 244 and the value TN of the total number field 246 in a record in which the value of the device ID field 242 of the database server 200 is “1234” are a null value. FIG. 5 shows values of respective parameters at time t0.

At time t1, the client computer 500 transmits the device ID “1234” of the printer 600 connected to the client computer 500 and the consumption number UDN of consumables=3 to the application server 100 (Step S10 in FIG. 4). In Step S11, the application server 100 extracts a record in which the value of the device ID field 242 is “1234” from the database server 200 and acquires the value PN of the previous quantity field 244 and the value TN of the total number field 246. In the initial state, the values of the previous quantity field 244 and the total number field 246 are null. In Step S12, the application server 100 stores the value PN of the previous quantity field 244 in the variable LT. Likewise, the application server 100 stores the value TN of the total number field 246 in the variable UPDATE. FIG. 5 shows values of respective parameters at time t2. In Step S13, the application server 100 determines that the registration of the client having the device ID “1234” is a first time in that the variable LT is null. Accordingly, the application server 100 stores 0 as a predetermined initial value in the variable UPDATE. In addition, the application server 100 stores the consumption number UDN of consumables=3 in the variable LT. In this embodiment, the initial value of the variable UPDATE is set to 0, but another value may be used. For example, in the client obtaining first access during a certain period, it is possible to perform a flexible operation by changing the initial value into 5, for example. In Step S14, the application server 100 writes the value of the variable LT in the previous quantity field 244 of the database server 200 and writes the value of the variable UPDATE in the total number field 246 of the database server 200. FIG. 5 shows values of respective parameters at time t3.

Next, at time t4, the client computer 500 transmits the device ID “1234” of the printer 600 connected to the client computer 500 and the consumption number UDN of consumables=4 to the application server 100 (Step S20 in FIG. 4). In Step S21, the application server 100 extracts a record in which the value of the device ID field 242 is “1234” from the database server 200 and acquires the value PN of the previous quantity field 244 and the value TN of the total number field 246. At this time, the value PN of the previous field 244 is equal to 3 and the value TN of the total number field 246 is equal to 0. In Step S22, the application server 100 stores the value PN of the previous quantity field 244 in the variable LT. Likewise, the application server 100 stores the value TN of the total number field 246 in the variable UPDATE. In Step S23, the application server 100 determines that the registration of the client having the device ID “1234” is not the first time in that the variable LT is not null. Accordingly, the application server 100 stores a value (UDN−LT=1) obtained by subtracting the value of the variable LT from the value of the consumption number UDN of consumables in the variable 6. FIG. 5 shows values of respective parameters at time t5. The application server 100 adds the value of the variable δ to the value of the variable UPDATE, since the value of the variable δ is larger than 0. In addition, the consumption number UDN of consumables=4 is stored in the variable LT. In Step S24, the application server 100 writes the value of the variable LT in the previous quantity field 244 of the database server 200 and writes the value of the variable UPDATE in the total number field 246 of the database server 200. FIG. 5 shows values of respective parameters at time t6.

Next, at time t7, it is assumed that the data on the consumption number of consumables of the printer 600 connected to the client computer 500 are lost and a relation of the consumption number UDN of consumables=0 is satisfied. The reason of the loss of the data on the consumption number UDN of consumables is that a board is replaced due to breakdown of an EEPROM storing the consumption number UDN of consumables, for example. After the data on the consumption number of consumables are lost, the client computer 500 transmits the device ID “1234” of the printer 600 and the consumption number UDN of consumables=0 to the application server 100 (Step S30 in FIG. 4). In Step S31, the application server 100 extracts a record in which the value of the device ID field 242 is “1234” from the database server 200 and acquires the value PN of the previous quantity field 244 and the value TN of the total number field 246. In this case, the value PN of the previous quantity field 244 is equal to 4 and the value TN of the total number field 246 is equal to 1. In Step S32, the application server 100 stores the value PN of the previous quantity field 244 in the variable LT. Likewise, the application server 100 stores the value TN of the total number field 246 in the variable UPDATE. In Step S33, the application server 100 determines that the registration of the client having the device ID “1234” is not the first time in that the variable LT is not null. Accordingly, the application server 100 stores a value (UDN−LT=−4) obtained by subtracting the value of the variable LT from the value of the consumption number UDN of consumables in the variable δ. FIG. 5 shows values of respective parameters at time t8. The application server 100 stores the consumption number UDN of consumables=0 in the variable LT, since the value of the variable δ is negative In Step S34, the application server 100 writes the value of the variable LT in the previous quantity field 244 of the database server 200. FIG. 5 shows values of respective parameters at time t9.

In this embodiment, when the difference value δ between present transmission information (the consumption number UDN of consumables) and previous transmission information (the value PN of the previous quantity field 244) is negative, the total number field 246 is not updated and the value of the previous quantity field 244 is set as the value of the consumption number UDN of consumables. In consequence, the total cumulative number of consumables consumed in the printer 600 can be maintained appropriately.

### B. Comparative Example

Next, advantages of the embodiment will be described in comparison to a comparative example. In the comparative example, the description of the same constituent elements as those of the above-described embodiment is omitted.

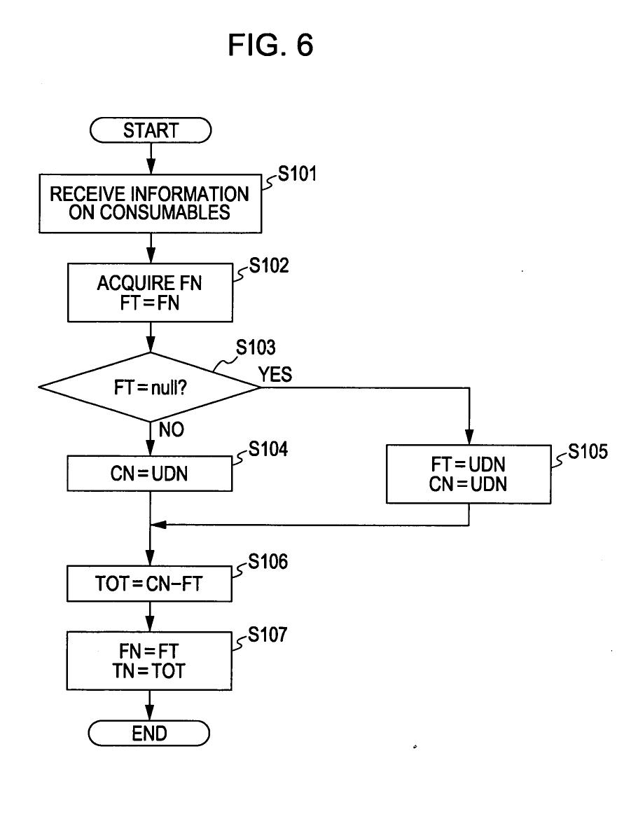

FIG. 6 is a flowchart illustrating a process sequence of the control unit 140 of the application server 100 according to the comparative example. The following variables are used in a process described below:

(1) information on consumables from a client,

UDN: the consumption number of consumables,

(2) values of fields of database,

FN: a value of the first quantity field (where a first consumption number UDN of consumables is stored),

TN: a value of the total number field,

(3) internal variables of the application server,

FT: a variable maintaining the value FN of the first quantity field,

CN: a variable maintaining a present consumption number UDN of consumables, and

TOT: a variable representing a cumulative consumption number of consumables.

In Step S101, information on the consumables transmitted from the client computer 500 is received through the network interface 120. This process is carried out at the same manner as that of Step S1 in FIG. 3. In Step S102, the control unit 140 acquires the value FN of the first quantity field and stores the value FN of the first quantity field in the variable FT. In Step S103, it is determined whether the value of the variables FT is null. When the value of the variable FT is null (initial state), the value of the consumption number UDN of consumables is stored in the variable FT and the value of the consumption number UDN of consumables is stored in the variable CN in Step S105. Then, the process proceeds to Step S106. Alternatively, when the value of the variable FT is not null, the value of the consumption number UDN of consumables is stored in the variable CN in Step S104. Then, the process proceeds to Step S106. In Step S106, a difference value (CN−FT) obtained by subtracting the value of the variable FT from the value of the variable CN is stored in the variable TOP. In the comparative example, the value of the variable TOT represents the total number of consumables consumed in the printer 600. In Step S107, the value of the variable TOT is written to the total number field 246. At this time, only in the first registration, the value of the variable FT is written in the first quantity field. Here, the first quantity field refers to a field used to store the value registered for the first time, as the consumption number UDN of consumables stored in the memory of the printer 600.

In the process sequence according to the above-described comparative example, even when the value (UDN−FT) of the variable TOT obtained by subtracting the value FN of the first quantity field from the consumption number UDN of consumables received from the client is negative, the negative value is written as the value TN of the total number field of the database. Therefore, there is a possibility that a wrong total number of consumables is registered in the value TN of the total number field.

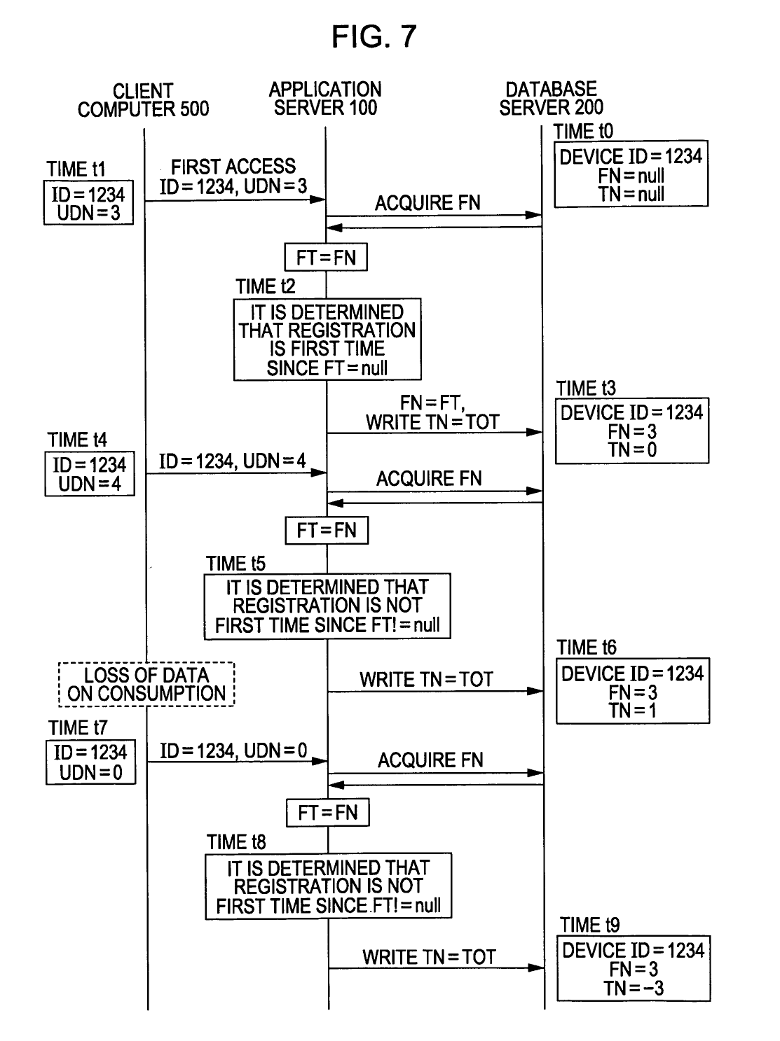

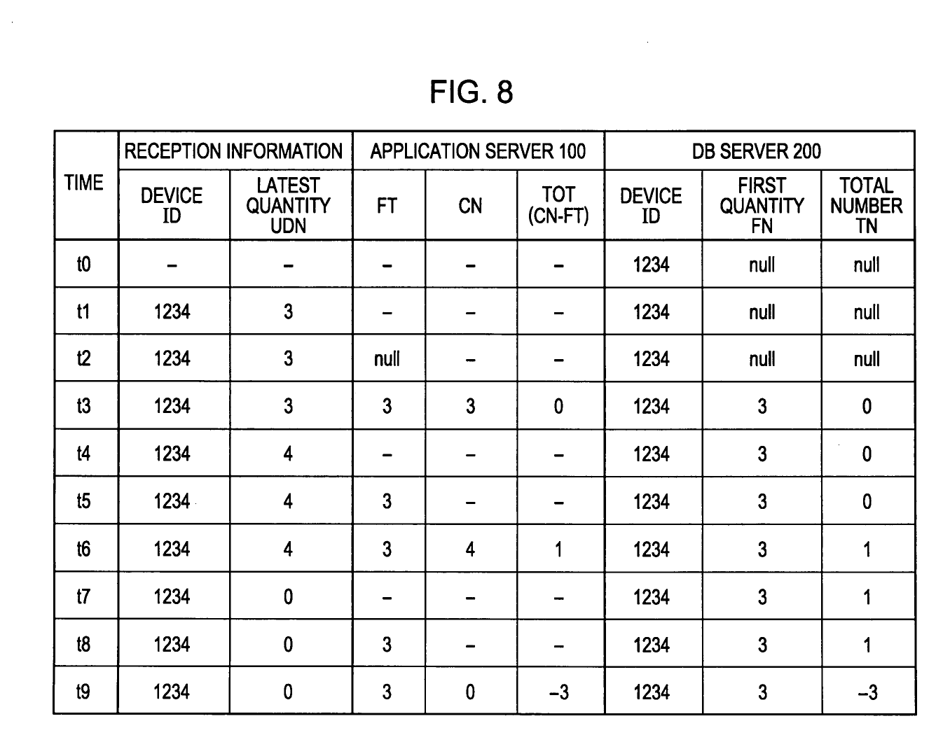

FIG. 7 is an explanatory diagram illustrating a process flow of the information collecting system 10 according to the comparative example. FIG. 8 is an explanatory diagram illustrating the contents of data at respective time points of FIG. 7. Hereinafter, the above-described embodiment and the comparative example will be compared to each other with reference to FIGS. 7 and 8.

In FIG. 7, information on the consumables having the same contents as those of FIG. 4 is transmitted from the client computer 500 at respective time points, that is, time t1, time t4, and time t7. Then, the process carried out by the application server 100 ends. At this time, the values of the respective fields of the database server 200 at the respective time points, that is, time t3, time t6, and time t9 when the fields of the database server 200 are updated are worthy of notice. That is, the value TN of the total number field is maintained as an appropriate value (TN=1) until time t6, but it can be known that an inappropriate value (TN=−3) is registered in the value TN of the total number field at time t9. The same is applied in FIG. 8. The reason of the registration of the inappropriate value is that the consumption number UDN=0 of consumables is received due to the loss of the data on the consumption number of consumables of the printer 600 connected to the client computer 500 before time t7. In FIG. 4, however, it can be known that the value TN of the total number field is maintained as the appropriate value (TN=1) even at time t9 after the reception of the consumption number UDN=0 of consumables.

In the comparative example, the exact total number cannot be maintained, since an abnormal negative value is stored in the total number field 246 in the case where the process is continuously carried out after the loss of the data on the consumption number of consumables. In the above-described embodiment, however, when the data on the consumption number are lost, the total number field 246 is not updated and the value of the previous quantity field 244 is set as the value of the consumption number UDN of consumables received at the present time. In consequence, it is possible to appropriately maintain the value of the total number field 246.

### C. Modified Examples

The invention is not limited to the above-described embodiment, but modified in various forms without departing the gist of the invention. For example, the following modifications can be made.

### C1. Modified Example 1

In the above-described embodiment, one kind of the consumption number UDN of consumables stored in a printer has been used, but plural kinds of consumption numbers UDN of consumables may be stored. For example, the plural kinds of consumption numbers UDN of consumables may be separately stored by distinguishing black ink from color ink. In this case, it is preferable that plural previous quantity fields and plural total number fields of the database server are provided in correspondence with the consumption numbers UDN of consumables.

### C2. Modified Example 2

In the above-described embodiment, the technique for collecting the information on the consumption number of ink cartridges has been described. However, the invention is applicable to a technique for collecting information on the consumption number of consumables other than the ink cartridges. For example, the total number of consumables such as toner cartridges, photographic sheets, and films can be obtained by carrying out the process of the embodiment. The invention is applicable to a device other than a printer. For example, the total consumption number of CD-R (DVD-R) of a CD-RW drive (DVD-RW drive) can be obtained.

### C3. Modified Example 3

In the above-described embodiment, one application server, one database server, and one WEB server are provided, but a plurality of the respective servers may be provided. For example, when numerous clients are connected and a lot of access is estimated, it is preferable that a plurality of WEB servers are provided and then a load balancer is provided.

### C4. Modified Example 4

In the above-described embodiment, the application server, the database server, and the WEB server are individually provided, but one server may be provided to function as the application server, the database server, and the WEB server.

### C5. Modified Example 5

In the above-described embodiment, the client and the information collecting system are connected to each other through an internet, but may be constructed through an intranet.

What is claimed is:

1. An information collecting device comprising:
a network interface unit which receives information on consumables from a plurality of devices connected through a network;
a database access unit which accesses a database storing the information on consumables of each of the devices; and
a control unit which controls the network interface unit and the database access unit,
wherein the information on consumables contains a device ID assigned to each of the devices and the consumption number of consumables as the number of consumables consumed by each of the devices,
wherein from the database, the database access unit acquires a value of a device ID field used to store the device ID, a value of a previous quantity field used to store the consumption number of consumables received at previous time, and a value of a total number field used to store the total number of consumables consumed by each of the devices, and
wherein the control unit includes:
a unit storing the consumption number of consumables in the previous quantity field and maintains the value of the total number field without update, when a difference value obtained by subtracting the value of the previous quantity field from the consumption number of consumables received from each of the devices is negative;
a unit storing the consumption number of consumables in the previous quantity field and adds the difference value to the value of the total number field, when the difference value is positive; and
a unit controlling the database access unit so as to store a predetermined initial value in the total number field, when the information on consumables received from each of the devices is first information on each of the devices.

2. An information collecting system comprising:
an information collecting device; and
a database server,
wherein the information collecting device includes a network interface unit receiving information on consumables from a plurality of devices connected through a network, a database access unit which accesses a database storing the information on consumables of each of the devices, and a control unit which controls the network interface unit and the database access unit,
wherein a table of the database server includes a device ID field used to store a device ID, a previous quantity field used to store the consumption number of consumables received at previous time, and a total number field used to store the total number of consumables consumed by each of the devices,
wherein the information on consumables contains the device ID assigned to each of the devices and the consumption number of consumables as the number of consumables consumed by each of the devices,
wherein from the database, the database access unit acquires a value of the device ID field, a value of the previous quantity field, and a value of the total number field, and
wherein the control unit stores the consumption number of consumables in the previous quantity field and maintains the value of the total number field without update, when a difference value obtained by subtracting the value of the previous quantity field from the consumption number of consumables received from each of the devices is negative.

3. An information collecting method comprising:
(a) receiving information on consumables from a device connected through a network; and
(b) accessing a database which stores the information on consumables of the device,
wherein the information on consumables contains a device ID assigned to the device and the consumption number of consumables as the number of consumables consumed by the device, and
wherein (b) the accessing includes:
(b1) accessing a device ID field used to store the device ID;
(b2) accessing a previous quantity field used to store the consumption number of consumables received at previous time;
(b3) accessing a total number field used to store the total number of consumables consumed by the device; and
(b4) storing the consumption number of consumables in the previous quantity field and maintaining a value of the total number field without update, when a difference value obtained by subtracting a value of the previous quantity field from the consumption number of consumables received from the device is negative.
